(19) United States
(12) Patent Application Publication
(10) Pub. No.: US 2026/0245853 A1
(43) Pub. Date: Aug. 20, 2026

(54) SYSTEM AND A METHOD FOR RAPID SAMPLE PREPARATION FOR CHARGED PARTICLES MICROSCOPY

(71) Applicant: KOC UNIVERSITESI, Istanbul (TR)

(72) Inventors: Abdullah KEPCEOGLU, Istanbul (TR); Anjum Naeem MALIK, Istanbul (TR); Hasan DEMIRCI, Istanbul (TR); Ismail LAZOGLU, Istanbul (TR)

(73) Assignee: KOC UNIVERSITESI, Istanbul (TR)

(21) Appl. No.: 19/161,744

(22) PCT Filed: Mar. 3, 2023
(86) PCT No.: PCT/TR2023/050207

§ 371 Date: Sep. 3, 2025

(51) Int. Cl. H01J 49/16; G01N 1/42

(52) U.S. Cl. CPC H01J 49/165; G01N 1/42

(57) ABSTRACT

The provided is a system for rapid sample preparation for charged particles microscopy including a plunger assembly including a shaft, a holder for reversibly receiving an EM sample grid at a first end of the shaft, and a triggering mechanism configured to cause the plunger assembly to move from a first position to a second position upon occurrence of a triggering event; a charged particle source configured to emit a charged particle beam towards the EM sample grid; a cryogen reservoir configured to position a cryogenic liquid to receive the EM sample grid when the plunger assembly moves to the second position. A method for rapid sample preparation for charged particles microscopy is also provided.

### CROSS-REFERENCE TO THE RELATED APPLICATIONS

This application is the national phase entry of International Application No. PCT/TR2023/050207, filed on Mar. 3, 2023, the entire contents of which are incorporated herein by reference.

### TECHNICAL FIELD

The present invention relates to a system for rapid sample preparation for charged particles microscopy.

### BACKGROUND

Demand on the fast and reliable sample preparation method for biomolecules to investigate structural properties using charged particle microscopy rose due to the developing microscopy capabilities. A prior art publication in the technical field of the invention may be referred to as U.S. Pat. No. 7,312,444B1, which discloses an apparatus and method for focusing, separating, and detecting gas-phase ions using the principles of RF/DC quadrupole fields at high pressures, at or near atmospheric pressure. The invention provides an additional improvement to the prior art.

### SUMMARY

An object of the present invention is to provide a fast and reliable sample preparation system for charged particle microscopy of the biomolecules and various samples.

The present invention proposes a system for rapid sample preparation for charged particles microscopy comprising a plunger assembly comprising a shaft, a holder for reversibly receiving an electron microscope (EM) sample grid at a first end of the shaft, and a triggering mechanism configured to cause the plunger assembly to move from a first position to a second position upon occurrence of a triggering event; an electro-spraying subsystem configured to emit a charged particle beam towards the EM sample grid; a cryogen reservoir configured to position a cryogenic liquid to receive the EM sample grid when the plunger assembly moves to the second position.

The system further comprises an electro-optic subsystem comprising an ion funnel for focusing a beam of charged particles using a series of stacked ring electrodes with decreasing inner diameter; a quadrupole mass filter for selecting focused charged particles based on their mass-to-charge ratio and a deflector for guiding the selected charged particles to the EM sample grid. Therefore, the samples of charged particles are deposited at a desired position on the EM sample grid by guiding the samples via electro-optic subsystem.

In a possible embodiment, the EM sample grid extends in a depth direction and a vertical direction. The deflector comprises at least two first type plates, which are arranged one top another with respect to vertical direction. In another words, the first type plates face each other. The first type plates extend in a horizontal direction and in the depth direction. Therefore, the samples of charged particles may be deflected in the depth direction and the vertical direction.

In a possible embodiment, the deflector further comprises at least two second type plates, which are arranged one top another with respect to depth direction (Y), extending in a horizontal direction (X) and the vertical direction (Z). The second type plates face each other. Therefore, the samples of charged particles may be deflected also in the horizontal direction and the vertical direction. Thus, depositing the charged particles on the EM sample grid may be controlled and guided.

A system for deflecting ions in a two-dimensional plane includes two parallel plates, oriented perpendicular to each other to create a Y-Z deflection in a horizontal direction. Each plate is maintained at a high voltage, creating a strong electric field between the plates. And is designed to control the deflection of ions (charged particles) in the depth and vertical directions by manipulating the voltage applied to each plate.

Ions (charged particles) are introduced into the electric field and are attracted or repelled depending on their charge. The strength of the electric field and the distance between the plates determine the magnitude of the deflection. By adjusting the voltages applied to each plate, the deflection angles in each direction can be controlled independently. This allows for precise control over the path of the ions in the Y-Z plane.

In a possible embodiment, the system further comprises a detecting device for detecting the particles on the EM sample grid. In a preferred embodiment of the present invention, the detecting device is a high-resolution camera. Thus, characterization of the deposited charged particles on the EM sample grid can be real-time monitored.

In a possible embodiment, the electro-spraying subsystem comprises a motorized syringe pump and a syringe assembly connected to the motorized syringe pump. Therefore, samples of charged particles are delivered with a controlled flow rate using a motorized syringe pump.

In a possible embodiment, the cryogenic reservoir has at least one sample container having at least one sample housing for holding the samples in the cryogenic reservoir. Therefore, the EM sample grid is placed inside the cryogenic reservoir safely.

In a possible embodiment, the sample housing has at least one elastic fixing member for fixing the EM sample grid when the EM sample grid is inserted into the sample housing Therefore, the EM sample grid may be fixed in the sample housing.

In a possible embodiment, the sample container is arranged in the cryogenic reservoir in a rotatable manner. Therefore, the cooling process is conducted in a more efficient manner.

The present invention also proposes a method for rapid sample preparation for charged particles microscopy which is suitable to use in a system comprising the steps of: providing an EM sample grid; emitting a charged particle beam towards the EM sample grid, by the charged particle subsystem; focusing a beam of charged particles using a series of stacked ring electrodes with decreasing inner diameter, by an ion funnel; selecting the focused charged particles based on their mass-to-charge ratio, by a quadrupole mass filter; guiding the selected charged particles to the EM sample grid, by the deflector. Therefore, the samples of charged particles are deposited at a desired position on the EM sample grid even under atmospheric pressure conditions.

### BRIEF DESCRIPTION OF THE DRAWINGS

The accompanying drawings are given solely for the purpose of exemplifying the invention whose advantages over prior art were outlined above and will be explained in detail hereinafter:

FIG. 1 is a schematic view of the system according to the present invention.

FIG. 2 is schematic view of the system, according to the present invention.

FIG. 3 is a schematic view of the sample container comprising the sample housing according to the present invention.

FIG. 4 is a schematic view of the system according to the present invention.

### DETAILED DESCRIPTION OF THE EMBODIMENTS

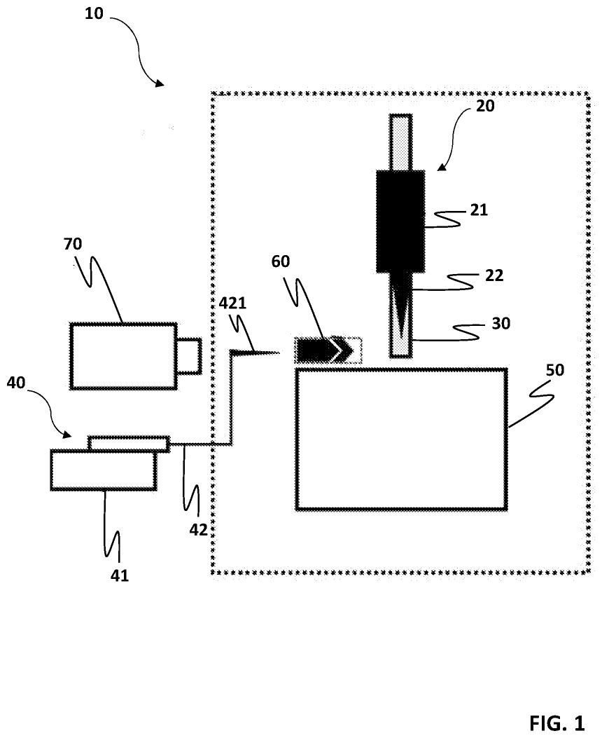

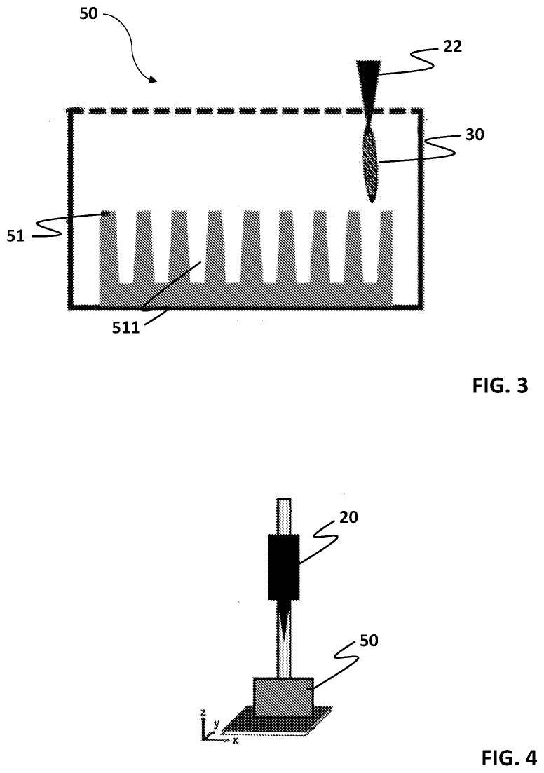

The present invention proposes a system (10) for rapid sample preparation for charged particles microscopy comprising a plunger assembly (20) comprising a shaft (21), a holder (22) for reversibly receiving an EM sample grid (30) at a first end of the shaft (21), and a triggering mechanism configured to cause the plunger assembly (20) to move from a first position to a second position upon occurrence of a triggering event; an electro-spraying subsystem (40) configured to emit a charged particle beam towards the EM sample grid (30); a cryogen reservoir (50) configured to position a cryogenic liquid to receive the EM sample grid (30) when the plunger assembly (20) moves to the second position. In FIG. 1, the plunger assembly (20) is in the first position in which the plunger assembly (20) is completely outside of the cryogen reservoir (50). In the second position, the plunger assembly (20) is inside the cryogen reservoir (50) at least partly. In FIG. 3, the plunger assembly (20) is in the second position. The system (10) further comprises an electro-optic subsystem (60) which is arranged between the electro-spraying subsystem (40) and the EM sample grid (30). The electro-spraying subsystem (40) comprises an ion funnel (61) arranged in front of the electro-spraying subsystem (40). The ion funnel (61) focuses a beam of charged particles sprayed from the electro-spraying subsystem (40) using a series of stacked ring electrodes with decreasing inner diameter. The electro-optic subsystem (60) also comprises a quadrupole mass filter (62) for selecting charged particles which are focused by the ion funnel (61) based on their mass-to-charge ratio. The mass-to-charge ratio (m/z) is a physical quantity where m is the mass of the ion in atomic mass unit (amu) and z is the charge of the ion. The quadrupole mass filter (62) comprises four parallel metal rods. Each opposing rod pair is connected electrically, and a radio frequency (RF) voltage with a DC offset voltage is applied between one pair of rods and the other. The charged particles travel down the quadrupole between the rods. Only the charged particles of a certain mass-to-charge ratio will reach the detector for a given ratio of voltages: other ions have unstable trajectories and eventually ejected. This permits selection of a charged particle with a particular mass-to-charge ratio or allows the operator to scan for a range of mass-to-charge ratio values by continuously varying the applied voltage. The electro-optic subsystem (60) further comprises a deflector (63). The deflector (63) guides the charged particles selected by the quadrupole mass filter (62) to the EM sample grid (30). Therefore, charged particles are focused on a specific area of the EM sample grid (30). Also, the applied electrical field allows to selecting ions with desired mass range to deposit on the EM sample grid (30) and this allows “mass selective sample deposition” of the samples.

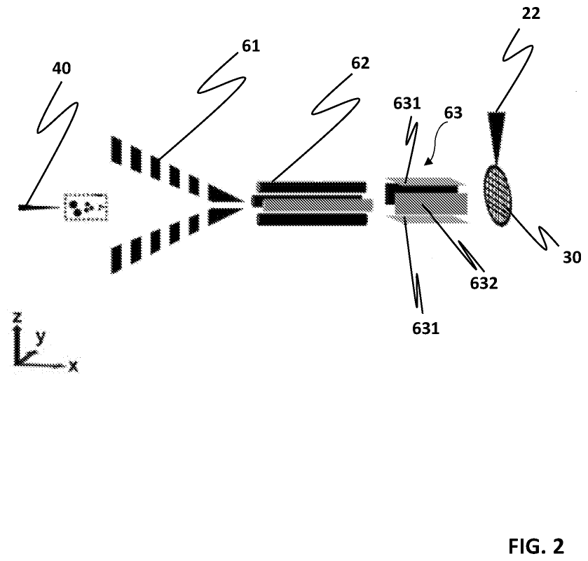

In another embodiment of the present invention, the EM sample grid (30) extends in a depth direction (Y) and a vertical direction (Z). The depth direction (Y) and the vertical direction (Z) may be any directions which are perpendicular to each other. As seen in FIG. 2, the deflector (63) comprises at least two first type plates (631), which are arranged one top another with respect to the vertical direction (Z). The first type plates (631) extend in a horizontal direction (X) and the depth direction (Y). The horizontal direction (X) extends in a parallel to a charged particle flow direction. The charged particles move between the first type plates (631). Therefore, the charged particles may be deflected with respect to vertical direction (Z) and the depth direction (Y) by using the first type plates (631). Thus, the charged particles may be disposed at a desired position on the EM sample grid (30). The depth direction (Y), the vertical direction (Z) and the horizontal direction (X) are perpendicular to each other. The directions (X, Y, Z) may be any directions which are perpendicular to each other. Ions (charged particles) are introduced into the electric field and are attracted or repelled depending on their charge. The strength of the electric field and the distance between the plates determine the magnitude of the deflection. By adjusting the voltages applied to each plate, the deflection angles in each direction can be controlled independently. This allows for precise control over the path of the ions in the Y-Z plane.

In another embodiment of the present invention, the deflector (63) further comprises at least two second type plates (632), which are arranged one top another with respect to depth direction (Y). As seen in FIG. 2, these two second type plates (632) extend in a horizontal direction (X) and in the vertical direction (Z). The charged particles travel between these two second type plates (632). Therefore, the charged particles are focused on a specific area of the EM sample grid (30) by deflecting the charged particles in both of depth direction (Y) and the vertical direction (Z).

In another embodiment of the present invention, a detecting device (70) is provided for detecting the particles on the EM sample grid (30). Thus, the travel of the particles from the electro-spraying subsystem (40) to the EM sample grid (30) may be observed.

In another embodiment of the present invention, the detecting device (70) is a high speed and/or high-resolution camera. Investigation, inspection and characterization of the deposited charged particles on the EM sample grid (30) can be real-time monitored by a high-speed/high-resolution camera and optical setup using a wide spectral range of light (LED, lasers etc.). The optical setup may comprise a light sheet which allows characterization of the particle dynamics inside plume/Taylor Cone.

In another embodiment of the present invention, the electro-spraying subsystem (40) comprises a motorized syringe pump (41) and a syringe assembly (42) connected to the motorized syringe pump (41). Investigated samples of charged particles load into the syringe assembly (42) and samples of charged particles were delivered with a controlled flow rate using a motorized syringe pump (41). Syringe assembly (42) has a needle (421) provided at the end of the syringe assembly (42).

In another embodiment of the present invention, the cryogenic reservoir (50) has at least one sample container (51) having at least one sample housing (511) for holding the samples in the cryogenic reservoir (50). The cryogenic reservoir (50) comprises a central cavity for receiving a cooling medium by means of which a specimen can be vitrified, for example liquid ethane. The cryogenic reservoir (50) may furthermore comprise an annular channel surrounding the central cavity, for example, into which a second cooling medium, such as liquid nitrogen, can be introduced. Said medium can be used for cooling the ethane and/or for temporary storage of specimens that are finished. The cryogenic reservoir (50) can be moved upwards and downwards by means of an associated actuator. The cryogenic reservoir (50) has at least one sample container (51) having at least one sample housing (511) for holding the samples in the cryogenic reservoir (50). Preferably, the sample container (51) bas plurality of sample housings (511). The sample housings (511) may be provided in the sample container (51) in a linear array, as shown in FIG. 3.

In another embodiment of the present invention, the sample container (51) is arranged in the cryogenic reservoir (50) in a rotatable manner. In this configuration, the sample housings (511) are provided in the sample container (51) in a circular array.

In another embodiment of the present invention, the sample housing (511) has at least one elastic fixing member for fixing the EM sample grid (30) when the EM sample grid (30) is inserted into the sample housing (511). The elastic fixing member may be a spring. The EM sample grids (30) are experienced with a lateral force with an elastic fixing member (640) to hold a fixed position during acceleration of the plunger assembly (20).

The present invention proposes also a method for rapid sample preparation for charged particles microscopy which is suitable to use in a system (10) comprising the steps of: providing an EM sample grid (30); emitting a charged particle beam towards the EM sample grid (30), by the charged particle subsystem (40); focusing a beam of charged particles using a series of stacked ring electrodes with decreasing inner diameter, by an ion funnel (61); selecting the focused charged particles based on their mass-to-charge ratio, by a quadrupole mass filter (62); guiding the selected charged particles to the EM sample grid (30), by the deflector (63). Therefore, the samples of charged particles are deposited at a desired position on the EM sample grid (30) even under atmospheric pressure conditions.

### REFERENCE NUMBERS

10. System
20. Plunger assembly
   21. Shaft
   22. Holder
30. EM sample grid
40. Electro-spraying subsystem
   41. Motorized syringe pump
   42. Syringe assembly
      421. Needle
50. Cryogen reservoir
   51. Sample container
      511. Sample housing
60. Electro-optic subsystem
   61. Ion funnel
   62. Quadrupole mass filter
   63. Deflector
      631. First type plate
      632. Second type plate
70. Detecting device
X. Horizontal direction
Y. Depth direction
Z. Vertical direction

What is claimed is:

1. A system for rapid sample preparation for charged particles microscopy comprising:
a plunger assembly comprising a shaft, a holder for reversibly receiving an electron microscope (EM) sample grid at a first end of the shaft, and a triggering mechanism configured to cause the plunger assembly to move from a first position to a second position upon occurrence of a triggering event;
an electro-spraying subsystem configured to emit a charged particle beam towards the EM sample grid;
a cryogenic reservoir configured to position a cryogenic liquid to receive the EM sample grid when the plunger assembly moves to the second position; wherein the system further comprises an electro-optic subsystem comprising an ion funnel for focusing a beam of charged particles using a series of stacked ring electrodes with decreasing inner diameter; a quadrupole mass filter for selecting focused charged particles based on a their mass-to-charge ratio of the focused charged particles and a deflector for guiding the focused charged particles to the EM sample grid.

2. The system according to claim 1, wherein the EM sample grid extends in a depth direction and a vertical direction; wherein the deflector comprises at least two first type plates, which are arranged one top another with respect to the vertical direction, extending in a horizontal direction and in the depth direction.

3/ The system according to claim 1, wherein the deflector further comprises at least two second type plates, which are arranged one top another with respect to depth direction, extending in a horizontal direction and vertical direction.

4. The system according to claim 1, wherein a detecting device is provided for detecting the particles on the EM sample grid.

5. The system according to claim 4, wherein the detecting device is a high speed and/or high-resolution camera.

6. The system according to claim 1, wherein the electro-spraying subsystem comprises a motorized syringe pump and a syringe assembly connected to the motorized syringe pump.

7. The system according to claim 1, wherein the cryogenic reservoir has at least one sample container having at least one sample housing for holding samples in the cryogenic reservoir.

8. The system according to claim 7, wherein the sample container is arranged in the cryogenic reservoir in a rotatable manner.

9. The system according to claim 7, wherein the sample housing has at least one elastic fixing member for fixing the EM sample grid when the EM sample grid is inserted into the sample housing.

10. A method for rapid sample preparation for charged particles microscopy, wherein the method is suitable to use in the system according to claim 1 and comprises steps of:
providing the EM sample grid;
emitting the charged particle beam towards the EM sample grid, by the electro-spraying subsystem;
focusing a beam of charged particles using a series of stacked ring electrodes with decreasing inner diameter, by the ion funnel;
selecting the focused charged particles based on a mass-to-charge ratio of the focused charged particles, by the quadrupole mass filter;
guiding the focused charged particles to the EM sample grid, by the deflector.

11. The system according to claim 2, wherein the deflector further comprises at least two second type plates, which are arranged one top another with respect to the depth direction, extending in the horizontal direction and the vertical direction.

12. The system according to claim 2, wherein a detecting device is provided for detecting the particles on the EM sample grid.

13. The system according to claim 3, wherein a detecting device is provided for detecting the particles on the EM sample grid.

14. The system according to claim 2, wherein the electro-spraying subsystem comprises a motorized syringe pump and a syringe assembly connected to the motorized syringe pump.

15. The system according to claim 3, wherein the electro-spraying subsystem comprises a motorized syringe pump and a syringe assembly connected to the motorized syringe pump.

16. The system according to claim 4, wherein the electro-spraying subsystem comprises a motorized syringe pump and a syringe assembly connected to the motorized syringe pump.

17. The system according to claim 5, wherein the electro-spraying subsystem comprises a motorized syringe pump and a syringe assembly connected to the motorized syringe pump.

18. The system according to claim 2, wherein the cryogenic reservoir has at least one sample container having at least one sample housing for holding samples in the cryogenic reservoir.

19. The system according to claim 3, wherein the cryogenic reservoir has at least one sample container having at least one sample housing for holding samples in the cryogenic reservoir.

20. The system according to claim 4, wherein the cryogenic reservoir has at least one sample container having at least one sample housing for holding samples in the cryogenic reservoir.
